(19) United States
(12) Patent Application Publication
(10) Pub. No.: US 2013/0194252 A1
(43) Pub. Date: Aug. 1, 2013

(54) AUTOSTEREOSCOPIC THREE-DIMENSIONAL IMAGE DISPLAY DEVICE USING EXTENSION OF VIEWING ZONE WIDTH

(71) Applicants: Sung Kyu Kim, Seoul (KR); Ki Hyuk Yoon, Seoul (KR)

(72) Inventors: Sung Kyu Kim, Seoul (KR); Ki Hyuk Yoon, Seoul (KR)

(21) Appl. No.: 13/690,317

(22) Filed: Nov. 30, 2012

(30) Foreign Application Priority Data
Jan. 31, 2012 (KR) 10-2012-0009410

(51) Int. Cl. G06T 15/00

(52) U.S. Cl. CPC G06T 15/00
USPC 345/419

(57) ABSTRACT

An autostereoscopic 3D image display device using time division is provided. The image display device includes a backlight, an image display panel, a controller, and a viewer position tracking system. The backlight includes a plurality of line sources which are disposed at certain intervals. The image display panel displays a 3D image. The controller controls the backlight and a viewing-point image of the image display panel. The viewer position tracking system determines pupil position of a viewer and transfers position information to the controller. The image display panel provides two or more viewing points. The line sources configure three or more line source sets that are separately driven. The controller adjusts a viewing-point width of a unit viewing point and the distance between adjacent viewing points to be 1.5 or more times the distance between both eyes of a viewer.

### CROSS-REFERENCE TO RELATED APPLICATION

This application claims priority to and the benefit of Korean Patent Application No. 2012-0009410, filed on Jan. 31, 2012, the disclosure of which is incorporated herein by reference in its entirety.

### BACKGROUND

1. Field of the Invention

The present invention relates to an autostereoscopic three-dimensional (3D) image display device, and more particularly, to an autostereoscopic 3D image display device that separates a viewing zone by using a plurality of line sources without using an optical plate such as a lenticular lens or a parallax barrier, and forms a basic unit viewing zone greater than a general binocular distance by using three or more line source sets, thus having enhanced resolution compared to the existing scheme.

2. Discussion of Related Art

General autostereoscopic 3D image display devices separate a viewing zone by using an optical plate such as a lenticular lens or a parallax barrier. In this case, a viewer separately views a left-eye viewing-point image and a right-eye viewing-point image from a viewing position, and thus views a 3D image. However, there are some limitations in commercializing autostereoscopic 3D image display devices at present.

First, crosstalk occurs between binocular viewing-point images, and the brightness of each of the binocular viewing-point images is not uniform horizontally. Due to this reason, a viewer may feel severe fatigue when continuously viewing 3D images, and the quality of an image is degraded even by slight horizontal movement. As an example, FIG. 1 shows the brightness distribution of viewing zones by viewing point according to horizontal movement from the optimum viewing position in a conventional autostereoscopic 3D image display device using a parallax barrier or a lenticular lens. In FIG. 1, on the assumption that an interval (about 65 mm) between viewing points is the same as an interval between the left-eye pupil and right-eye pupil of a viewer, when the viewer at the optimum viewing position is located in the front of a 3D image display device, the left eye of the viewer is located at the center (position A) of a first viewing zone, and the right eye of the viewer is located at the center (position C) of a second viewing zone, both eyes of the viewer respectively deviate from position A and position C and then the image brightness of a corresponding viewing zone for each viewing point becomes dark rapidly, lowering the quality of an image. Also, crosstalk occurs in which a first viewing-point image disposed in the first viewing zone and a second viewing-point image disposed in the second viewing zone are simultaneously viewed by the left eye of the viewer, and the second viewing-point image disposed in the second viewing zone and a third viewing-point image disposed in a third viewing zone are simultaneously viewed by the right eye of the viewer. Especially, when the left eye of the viewer is located at a middle position (position B) between the first and second viewing zones and the right eye of the viewer is located between the second and third viewing zones, the maximum crosstalk occurs.

Second, as the number of viewing points increases, the resolution of an image display panel decreases proportionally. Particularly, for a plurality of viewers, the resolution of an image display panel being reduced in proportion to the number of viewing points is a large drawback.

Third, in conventional autostereoscopic 3D image display devices, only a viewer who is located at a specific position (optimum viewing position) away from an image display device can view a clear 3D image. Consequently, when a viewer moves in a depth direction, the viewer cannot view a 3D image normally. This will now be described with reference to FIGS. 2A to 2D.

FIGS. 2A to 2D are diagrams for describing an example of a conventional autostereoscopic 3D image display device using a four-viewing point parallax barrier. In an optimum viewing position, viewing zones for respective viewing points are well separated as in FIG. 1, but if a viewer deviates from the optimum viewing distance (OVD) position in a depth direction and moves to a position P1 (position at a distance 0.5 times the OVD), a viewing zone for a left-eye viewing point and a viewing zone for a right-eye viewing point are not normally separated or overlap with adjacent viewing zones so that the viewer cannot normally view a 3D image (see FIG. 2C for viewing distribution at position P1). Also, although not shown in FIG. 2, even when the viewer moves to a position at a distance 1.5 times the OVD, as shown in FIG. 2D, a viewing-zone shape changes, and thus crosstalk increases. To provide a more detailed description on this with reference to FIG. 2C, considering the intersection of boundary lines between viewing zones in a dotted line illustrated at position P1 of FIG. 2A, when a pupil is located at the center of a viewing zone for one pixel at the position P1, although a viewing zone closest to the center of the pupil is selected from among viewing zones for different openings, depending on the case, a large amount of crosstalk is caused by all openings when a pupil is located at a boundary line between viewing zones. In this case, as described above, crosstalk per opening is inevitably maximized or nearly maximized. Therefore, crosstalk increases on average. This case occurs when a viewer deviates from the OVD. Accordingly, when a viewer deviates considerably from the OVD, a large amount of crosstalk occurs at all positions.

Therefore, as shown in FIGS. 2E, 2F and 2G, in a parallax barrier, considering only one opening line, namely, one 3D pixel line (for example, one line source is defined as one 3D pixel line in using a line source, and one lenticular lens is defined as one 3D pixel line in using a lenticular optical plate), as in the OVD of FIG. 2B, the shape of a viewing distribution is almost unchanged in FIG. 2E that shows a viewing distribution for each 3D pixel line in the OVD, FIG. 2F that shows a viewing distribution when the position of the viewer is a distance 0.5 times the OVD, and FIG. 2G that shows a viewing distribution in a position 1.5 times the OVD, and thus, considering viewing distribution for each 3D pixel line, the result of FIG. 2B may be applied even to a different depth.

Finally, conventional autostereoscopic 3D image display devices are designed so that one viewer can view a 3D image and not for a plurality of viewers to view a 3D image from different positions.

Therefore, there is need to develop an autostereoscopic 3D image display device that overcomes the above-described limitations, and moreover enables a plurality of viewers to view a natural 3D image while moving freely.

### SUMMARY OF THE INVENTION

The present invention is directed to provide an autostereoscopic 3D image display device using a line source and a pupil tracking system. The present invention designs an interval between adjacent viewing points greater than a binocular distance unlike in a general autostereoscopic two or more multi-viewing point 3D display device in which an interval between adjacent viewing points is within a general binocular distance (65 mm), and allocates three or more line sources to one 3D pixel line. Accordingly, the present invention minimizes brightness change of a 3D image caused by movement of a viewer in a conventional autostereoscopic 3D image display device, reduces crosstalk of binocular viewing-point images of a viewer to or to less than that of a glasses-type 3D image display device, and minimizes reduction in resolution of a 3D image.

The present invention is also directed to provide an autostereoscopic 3D image display device that overcomes the limitation of a position from which a viewer can view the optimum 3D image (the limitation of a conventional autostereoscopic 3D image display device as opposed to a glasses-type 3D image display device). Particularly, the present invention enables a viewer to view a 3D image of equal quality to an image viewed from the optimum viewing position, even when the viewer is moving in the distance direction (depth direction) of the 3D image display device.

The present invention is also directed to provide an autostereoscopic 3D image display device that overcomes the limitation of a conventional autostereoscopic 3D image display device in that it can provide an optimum 3D image to only one viewer, or can provide a 3D image to a plurality of viewers only within a range where movement is very restricted, and thus enables a plurality of viewers to continuously view natural 3D images while freely moving.

According to an aspect of the present invention, there is provided a 3D image display device including: a backlight configured to include a plurality of line sources which are disposed at certain intervals; an image display panel configured to display a 3D image; a controller configured to control the backlight and a viewing-point image of the image display panel; and a viewer position tracking system configured to determine pupil position of a viewer and transfer position information to the controller, wherein, the image display panel provides two or more viewing points, the line sources configure three or more line source sets that are separately driven, and the controller adjusts a viewing-point width of a unit viewing point and the distance between adjacent viewing points to be 1.5 or more times the distance between both eyes of a viewer.

Each of the line sources may be one of a self-emitting light source including an LED, an OLED, and an FED, or each of the line sources may be configured with an electrical high-speed shutter element including a light source and an FLCD, or a DMD.

The controller may provide a viewing-point image to the image display panel in synchronization with one of the three or more line sources that is selected and driven according to a signal from the viewer position tracking system.

The signal from the viewer position tracking system may include real-time 3D position information on both eyes of the viewer, and the controller may provide a viewing-point image in which a position corresponding to each eye of the viewer is closest to the center of a viewing zone of a viewing point, and remove other viewing-point images, in synchronization with one of the three or more line source sets.

By using the 3D position information on both eyes of the viewer, the controller may provide the viewing-point image in which the position corresponding to each eye of the viewer is closest to the center of the viewing zone of the viewing point, and removes the other viewing-point images, in synchronization with one of the three or more line source sets for each 3D pixel line.

The controller may provide a viewing-point image to the image display panel in synchronization with the three or more line sources that are sequentially driven in a time division scheme, according to the signal from the viewer position tracking system.

When there are a plurality of viewers, the viewer position information may include position information on both eyes of the plurality of viewers.

When N number (where N is an integer from three to sixteen) of line source sets are provided and the interval between unit viewing points and the distance between adjacent viewing points are N/2 of the distance between both eyes of the viewer in a viewing position, a plurality of viewing points formed by one of the line source sets and the image display panel may move by 1/N of the interval between the unit viewing points from viewing points formed by the other of the line source sets which is adjacent to the one of the line source sets and the image display panel.

A line width of each of the line sources may be within 25% of a width of a horizontal pixel in the image display panel.

### BRIEF DESCRIPTION OF THE DRAWINGS

The above and other objects, features and advantages of the present invention will become more apparent to those of ordinary skill in the art by describing in detail exemplary embodiments thereof with reference to the accompanying drawings, in which:

FIG. 1 is a conceptual diagram for describing a general viewing distribution at the position of a viewer in a conventional autostereoscopic 3D image display device;

FIG. 2A is a conceptual diagram for describing drawbacks that occur when a viewer moves in a depth direction in a conventional autostereoscopic 3D image display device using a parallax barrier;

FIG. 2B shows a viewing distribution at the optimum viewing position in the conventional autostereoscopic 3D image display device using a parallax barrier;

FIG. 2C shows the increase in crosstalk due to disparity between viewing zones when a viewer moves to a position P1 (which is a distance equal to half of an OVD depth) in the depth direction;

FIG. 2D shows the increase in crosstalk which occurs at a distance 1.5 times the OVD;

FIG. 2E shows a viewing distribution at the OVD by 3D pixel lines when a viewing zone is considered in units of a 3D pixel line;

FIG. 2F shows a viewing distribution by 3D pixel lines when the viewer moves to the position P1 (half of the OVD) in the depth direction;

FIG. 2G shows a result in which a viewing distribution is almost unchanged by depth movement, considering a viewing distribution in units of a 3D pixel line by simulating a viewing distribution when the viewer moves to a distance 1.5 times the OVD in a direction away from the OVD position;

FIG. 3A is a conceptual diagram for describing a two-viewing point 3D image display device using three line source sets, in which the distance between adjacent viewing points is designed to be 1.5 times a general binocular distance, according to an embodiment of the present invention;

FIGS. 3B to 3D are conceptual diagrams for describing an example in which a viewing zone of each of a plurality of line source sets is used according to on the position of a viewer;

FIG. 4 shows viewing uniformity simulation results based on the line width of a line source according to an embodiment of the present invention;

FIG. 5 is a conceptual diagram for describing a design condition for an interval between viewing points based on a condition n times a binocular distance;

FIG. 6A is a conceptual diagram for describing a two-viewing point 3D image display device having a basic viewing zone width and an interval (which is equal to a general binocular distance (65 mm)) between adjacent viewing points;

FIG. 6B is a conceptual diagram for describing a two-viewing point 3D image display device according to an embodiment of the present invention when having an interval between viewing points 1.5 times greater than a general binocular distance (65 mm) and a viewing zone width equal to the interval between viewing points;

FIGS. 7A and 7B are conceptual diagrams for describing a method of providing a 3D image to two viewers in a 3D image display device using a time division scheme according to another embodiment of the present invention; and

FIGS. 8 and 9 are conceptual diagrams for describing the concept of a 3D pixel line and a method of controlling a viewing-point image in units of a 3D pixel line when a viewer is moving in a depth direction, according to an embodiment of the present invention.

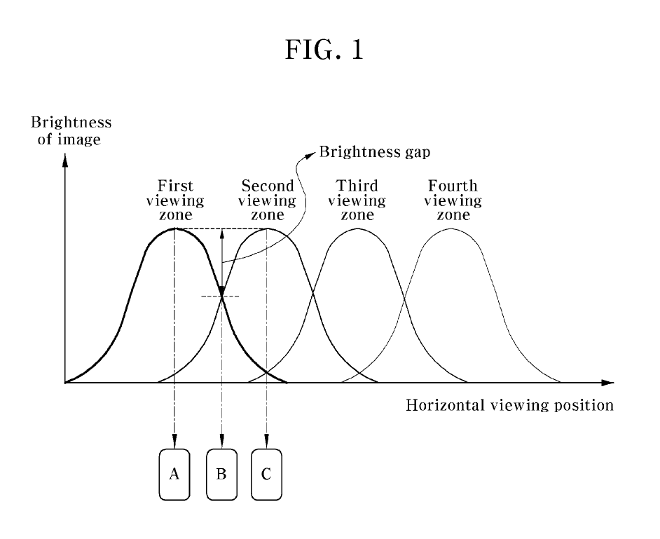

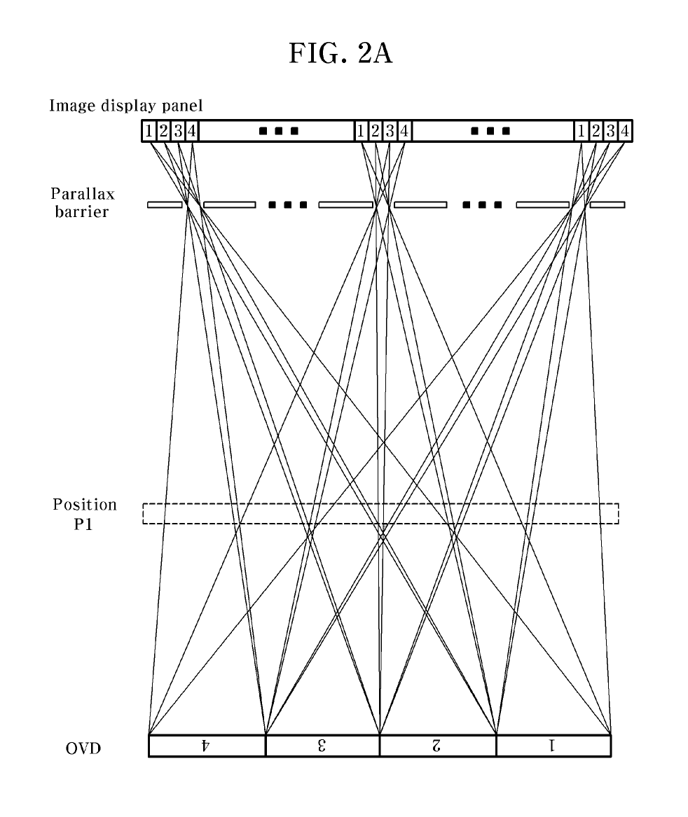

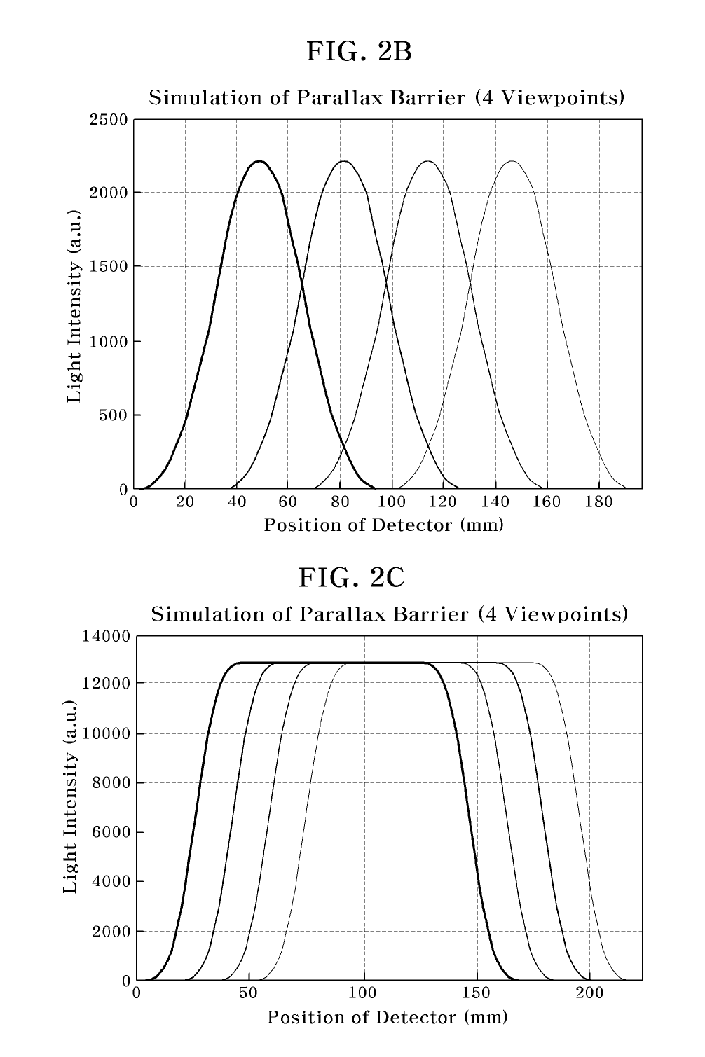

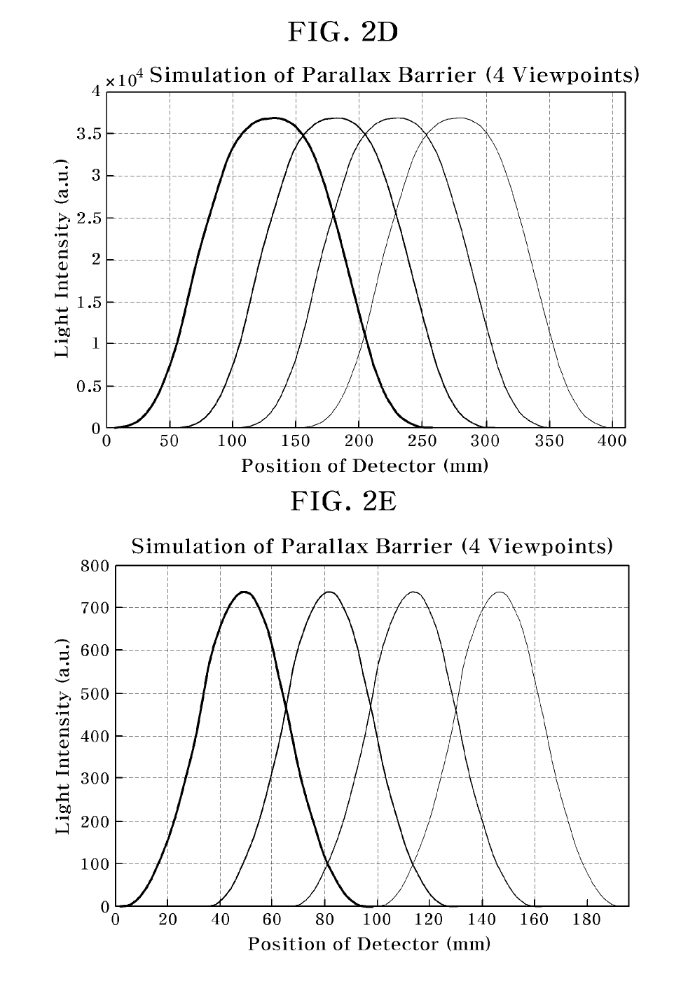

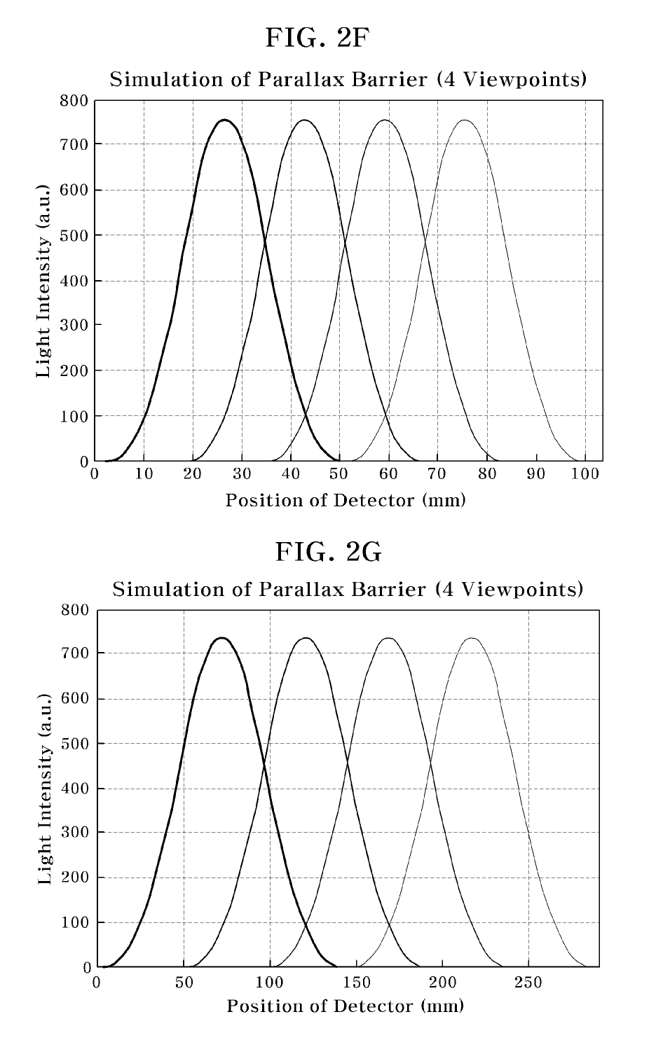

### DETAILED DESCRIPTION OF EXEMPLARY EMBODIMENTS

Exemplary embodiments of the present invention will be described in detail below with reference to the accompanying drawings. While the present invention is shown and described in connection with exemplary embodiments thereof, it will be apparent to those skilled in the art that various modifications can be made without departing from the spirit and scope of the invention.

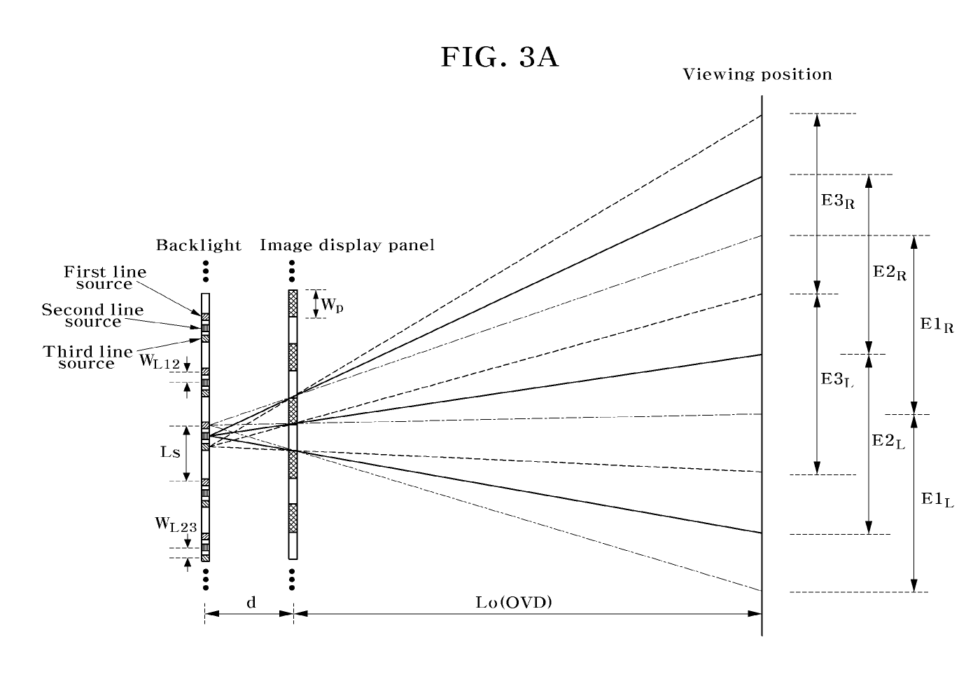

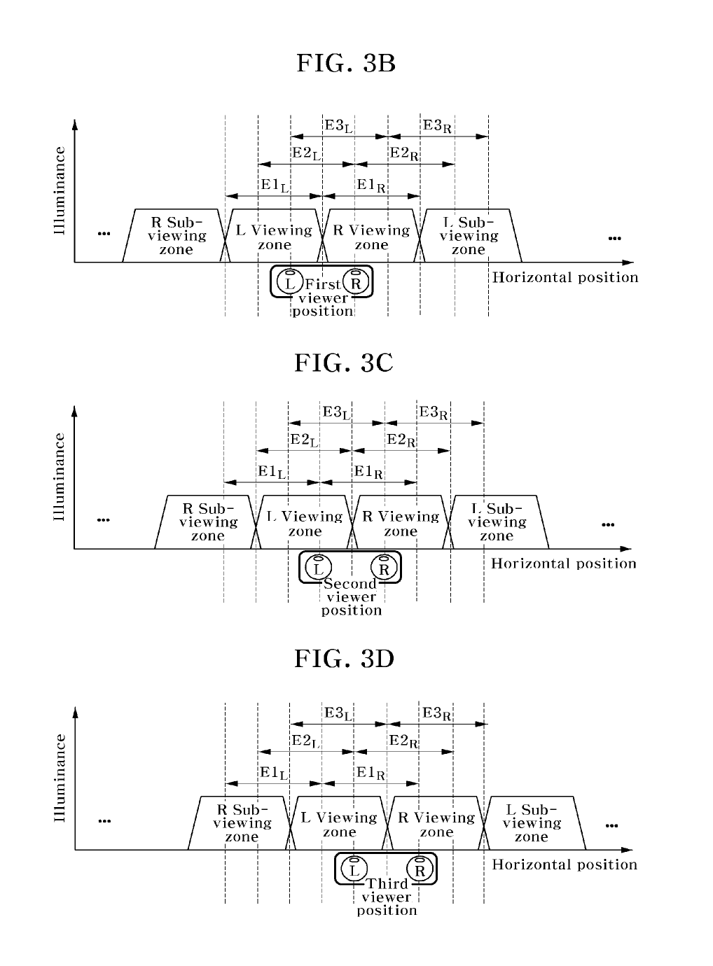

FIG. 3A is a conceptual diagram for describing a two-viewing point 3D image display device using three line source sets, in which a distance between adjacent viewing points is designed to be 1.5 times a general binocular distance, according to an embodiment of the present invention.

Referring to FIG. 3A, the 3D image display device includes: an image display panel that provides at least two viewing points to display a 3D image; and a backlight that is disposed to be separated by a certain distance from a rear surface of the image display panel. The backlight includes a plurality of line sources (hereinafter referred to as a first line source set), and second and third line source sets that include a plurality of line sources other than the first line source set.

The plurality of line sources that configure the first line source set of the backlight are disposed at certain intervals and allow viewing zones for respective viewing points to be separated at a viewing position of FIG. 3A in image information formed on the image display panel. In this case, a separation distance between the line sources configuring the second and third line source sets may be the same as a separation distance Ls between the line sources of the first line source set. Also, one line source of the first line source set and a line source of the second line source set adjacent thereto are separated from each other by a certain distance W_{L12}, and one line source of the second line source set and a line source of the third line source set adjacent thereto are separated from each other by a certain distance W_{L23}. In the design of two viewing points of FIG. 3A, separation distances W_{L12} and W_{L23} between three line source sets may be one-sixth of an interval Ls between line sources of each line source set. In this condition, a viewing zone formed by the first line source at a viewing position, a viewing zone formed by the second line source at the viewing position, and a viewing zone formed by the third line source at the viewing position are formed by moving one-third of an interval between viewing points. Each of the line sources, for example, is one of self-emitting light sources including an LED, an OLED, and an FED, or may be configured with an electrical high-speed shutter element including a light source and an FLCD, or a DMD.

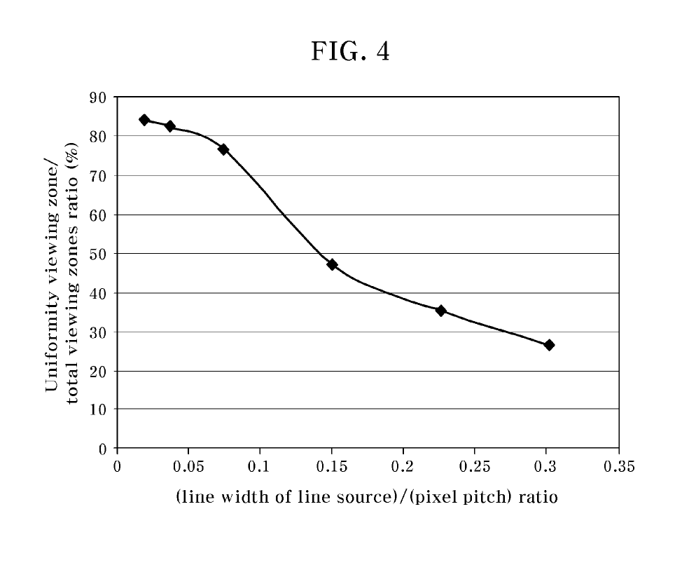

In such a configuration, the size of a uniform region of a brightness distribution of a viewing zone at each binocular viewing point, which is formed when each line source set operates at a viewing position, is relevant to a line width W_{LS} of each of three line sources configuring each line source set. That is, FIG. 4 shows that as the line width of a line source to the pixel pitch of the image display panel decreases, the uniform region of a viewing zone (which is formed by the first to third line source sets and the pixels of the image display panel displaying a viewing-point image) increases. The line width of a line source to a pixel pitch may become 0.25 or less, and thus the size of the uniform portion of a viewing zone may become 30% or more of an entire size.

Hereinafter, in regard of one viewer, when the central 3D coordinates of both eyes are acquired in real time, as described above with reference to FIG. 3, the principle of providing a clear 3D image with no crosstalk when a viewer is moving by using the image display panel providing two-viewing-point image information and three line source sets will be described with reference to FIGS. 3B to 3D.

In the two-viewing point 3D image display device of FIG. 3A, three line source sets are used, and the distance between adjacent viewing points is designed at 1.5 times a general binocular distance.

That is, it is set to be E1_{L}=E1_{R}=E2_{L}=E2_{R}=E3_{L}=E3_{R}=(general binocular distance×1.5)=65 mm×1.5.

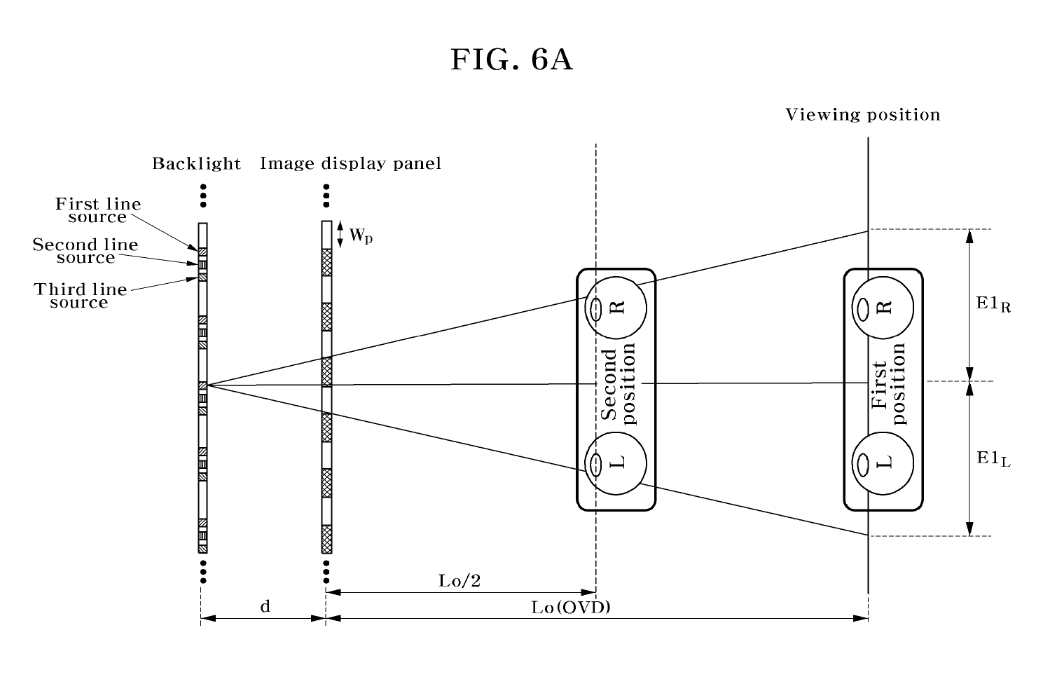

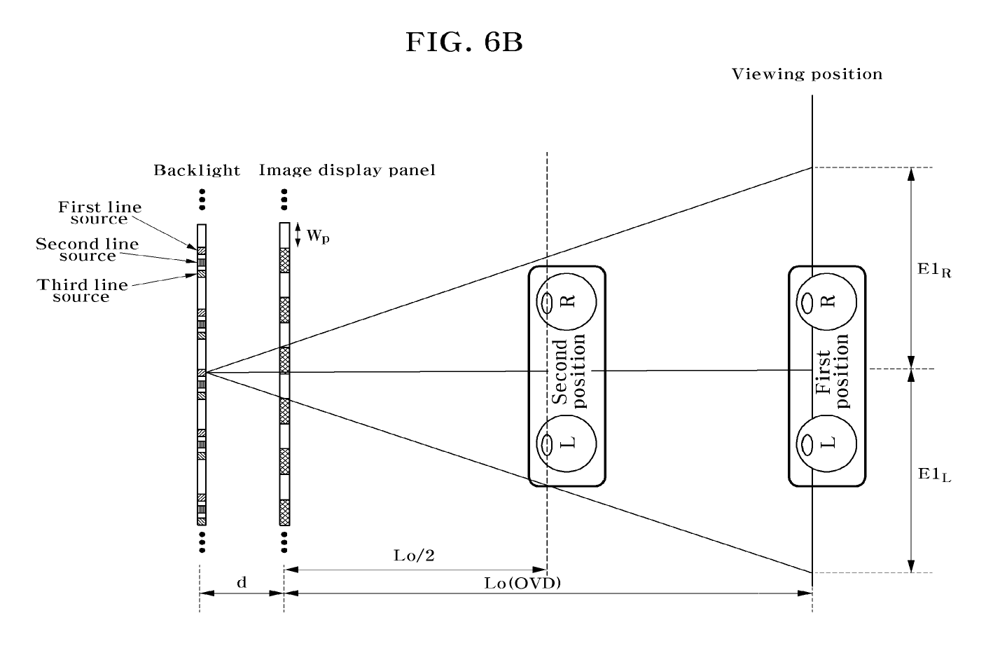

Designing the distance between adjacent viewing points as a distance 1.5 times the general binocular distance is for enabling a viewer to view a 3D image with no crosstalk when the viewer is located at the half position of the optimum viewing position as well as when the viewer is located at the designed optimum viewing position. In a conventional design (a binocular distance and an interval between the same viewing points), by moving to the half position of the OVD, an interval between viewing points is reduced by half, and thus, both eyes are located at the boundary of a viewing zone for a corresponding viewing point. Accordingly, crosstalk increases considerably. However, in an embodiment of the present invention, when the distance between adjacent viewing points is designed to be 1.5 times greater than a binocular distance, even though a viewer moves to the half position of the optimum viewing position, the viewer experiences minimal crosstalk similar to that of the optimum viewing distance (see FIGS. 6A and 6B).

As shown in FIG. 3B, 3C, or 3D, when both eyes are located in a viewing zone, a controller of the image display device drives only a line source corresponding to E1, E2, or E3 among three line sources, thus planarizing a viewing zone and providing a 3D image with no crosstalk. That is, a viewing-point image in which a position corresponding to each of a viewer's eyes is closest to the center of a viewing zone of a viewing point is provided in synchronization with one of the three line source sets which is selected and driven according to a signal from the viewer position tracking system, and the other viewing-point images are removed. In this case, the signal from the viewer position tracking system may include 3D position information on a viewer's eyes in real time.

For example, in FIG. 3B in which each eyeball of viewer is located at the optimum position of a viewing zone formed by the first line source, when a viewer position moves to the right and each eyeball of viewer reaches near the boundary of an L viewing zone and an R viewing zone respectively, the controller drives only the second line source according to the signal from the viewer position tracking system, and thus can provide the optimum 3D image as in FIG. 3C. Also, when the viewer moves further to the right, the controller drives only the third line source, and thus can provide the optimum 3D image as in FIG. 3D. When the viewer continuously moves to the same direction, a case similar to only the first line source being driven is repeated, and, by using a sub-viewing zone, the optimum 3D image can be provided as described above. In this example, a case in which line sources on a 3D pixel line are sequentially driven is shown. When such an application for each 3D line source is made for all line sources for forming a 3D screen, an entire 3D image can always be viewed in the optimum condition.

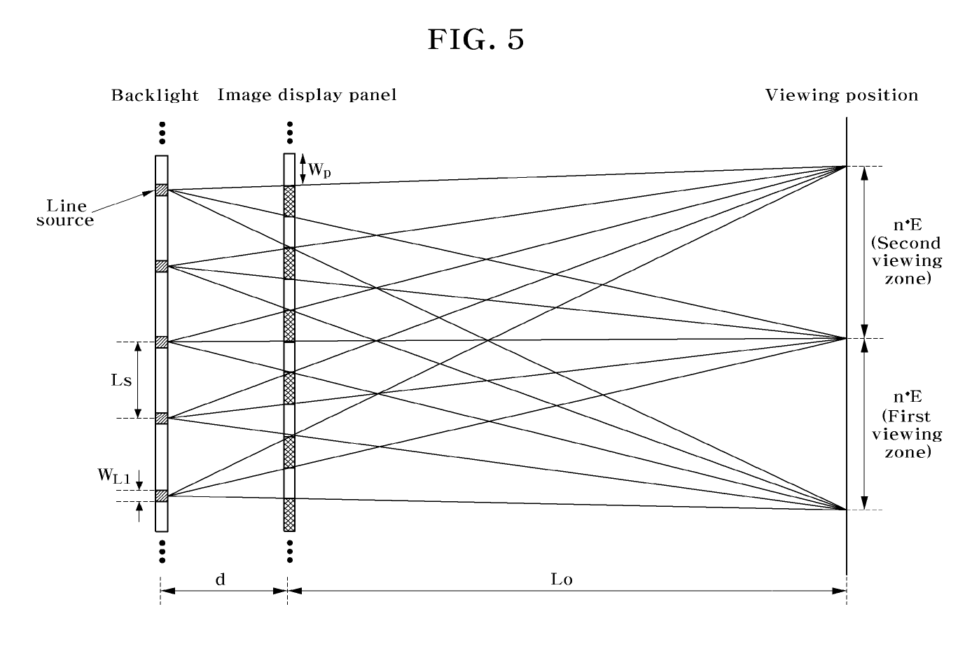

Hereinafter, an interval between viewing points based on a condition n times a binocular distance that is designed in two viewing points will be described with reference to FIG. 5.

Although FIG. 5 illustrates only one line source set, a case that uses three line source sets as in FIG. 3A satisfies a design condition that is illustrated in FIG. 5, and the interval between adjacent line source sets is determined according to the number of line source sets. As shown in FIG. 5, when an average binocular distance of a viewer is E, in the present invention, a designed interval between viewing points is set as n*E. In this case, “d:W_{P}=(d+1_{O}):n*E” is satisfied. In this equation, d is expressed as Equation (1).

$$d = \frac{{W}_{P} {L}_{O}}{n * E - {W}_{P}} \qquad ( 1 )$$

Moreover, when an interval “L_{S}” between line sources in a line source set is calculated from a proportional expression “L_{S}:(d+L_{O})=2W_{P}:L_{O}”, the following Equation (2) is obtained:

$${L}_{S} = 2 {W}_{P} \frac{d + {L}_{O}}{{L}_{O}} \qquad ( 2 )$$

When d is removed by substituting d of Equation (1) into Equation (2), the following Equation (3) is obtained:

$${L}_{S} = 2 {W}_{P} \frac{n * E}{n * E - {W}_{P}} \qquad ( 3 )$$

where L_{S} is the interval between line sources in one line source set, W_{P} is the pixel width in the image display panel, L_{O} is the distance from the image display panel to the optimum viewing position, and d is the distance between a line source set and the image display panel.

In Equation (3), when n=1, the general interval between viewing points is equal to the interval between both eyes. In the above-described example, when the three line source sets are used and the interval between both eyes is 1.5 times the interval between both eyes, n becomes 1.5. Equations (1) to (3) are obtained by formularizing the design method of the present invention. However, by substituting the number of design viewing points of 2 into two more viewing points, an arbitrary N viewing point may be expansion-applied.

When there are N number of line source sets and the interval between a distance (which is the distance between adjacent viewing points) and the interval between unit viewing points are N/2 of a viewer binocular distance in a viewing position, viewing points formed by one of the line source sets and the image display panel are moved by 1/N of the interval between the unit viewing points from viewing points that are formed by a line source set adjacent to one of the line source sets and the image display panel. A description on this will be made for the three line source sets with reference to FIG. 3A. FIG. 3A shows the viewing zone of each of two viewing points formed by the first to third line source sets and the pixels of the image display panel. In this case, the separation distance “W_{L12}” between adjacent line source sets is designed as ⅙. Under this condition, the horizontal position of a viewing zone formed by the first to third line source sets and the pixels of the image display panel is moved by one-third of a unit viewing zone for each line source set and formed. In this way, FIG. 3A exemplarily shows a case in which N is three. In a case in which N is an integer from three to sixteen, when the separation distance between adjacent line source sets is set as “1/(2*N)”, as shown in FIG. 3A, the horizontal movement position of each of viewing zones formed by adjacent line source sets is moved by 1/N of a unit viewing zone. Accordingly, as N increases, a suitable line source set is more accurately driven according to a viewer's position, thus always providing an image with minimal crosstalk.

In this case, N may be an integer from three to sixteen. This is because an LCD that is presently driven at the highest speed is driven at 480 Hz, and thus, when desiring to drive first to Nth line source sets at 30 Hz that is the lowest driving speed, N is required to be sixteen. That is, the first to Nth line source sets are driven at a frequency that is obtained by dividing 480 Hz by 16, and, by synchronizing and providing image information on a pixel suitable for the driving frequency, one frame corresponding to one period for which a line source set is driven is driven at 30 Hz. In this way, when a maximum of N is sixteen, the distance between adjacent viewing points and the interval between unit viewing points are 8 times corresponding to N/2 of a viewer binocular distance.

FIG. 6A is a conceptual diagram for describing a two-viewing point 3D image display device having a basic viewing zone width and an interval (which is equal to a general binocular distance (65 mm)) between adjacent viewing points. FIG. 6B is a conceptual diagram for describing a two-viewing point 3D image display device according to an embodiment of the present invention when having an interval between viewing points 1.5 times greater than a general binocular distance, (65 mm) and a viewing zone width equal to the interval between viewing points.

Referring to FIG. 6B, each viewing zone is 1.5 times a general binocular distance, and thus, even though a viewer moves to the half position of the OVD in a depth direction, by reflecting 3D information for tracking pupil position with only two viewing points and three line sources, the optimum 3D image with no crosstalk can be provided. On the other hand, in FIG. 6A, each viewing zone is 65 mm that is a general binocular distance, and crosstalk occurs when a viewer moves to the half position of the OVD.

According to another embodiment of the present invention, by using the above-described principle, the distance between viewing points may be designed to be 2 times the general binocular distance, four line sources may be disposed on one 3D pixel line, and the distance between line sources may be set to be one-eighth of the interval “L_{S}” between line sources in each line source set. Therefore, even when a viewer moves a longer distance in a depth direction, an optimum 3D image in which crosstalk and the change in the brightness of a viewing zone are minimized can be provided with only two viewing points. That is, a region in which the optimum 3D image is capable of being provided in the depth direction can be broadened with only two viewing points. Also, by increasing the number of line sources in a 3D pixel line, the optimum 3D image can be provided to a broader depth region without additionally decreasing resolution.

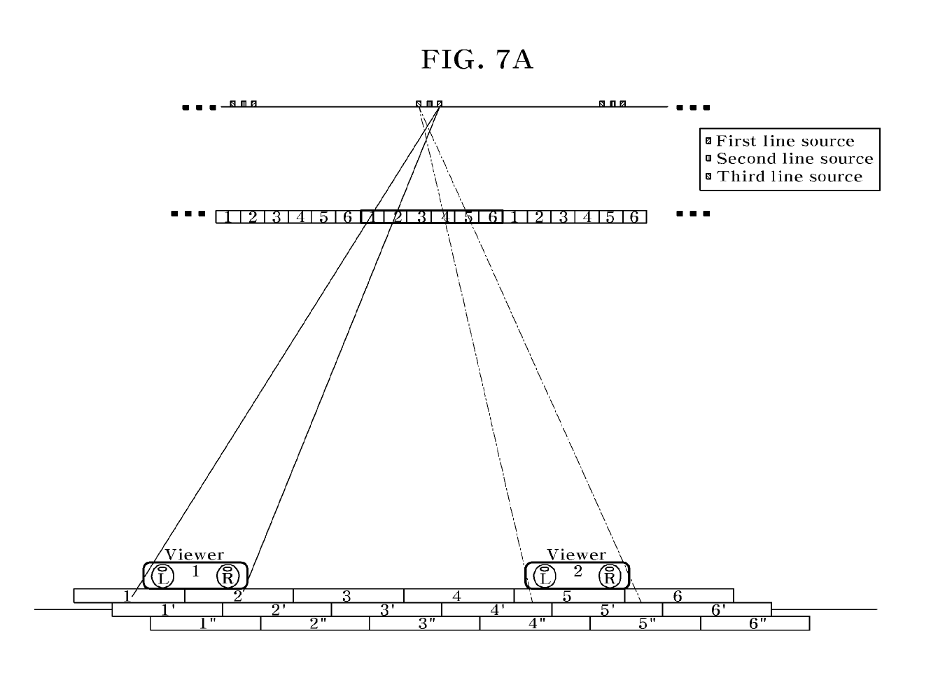

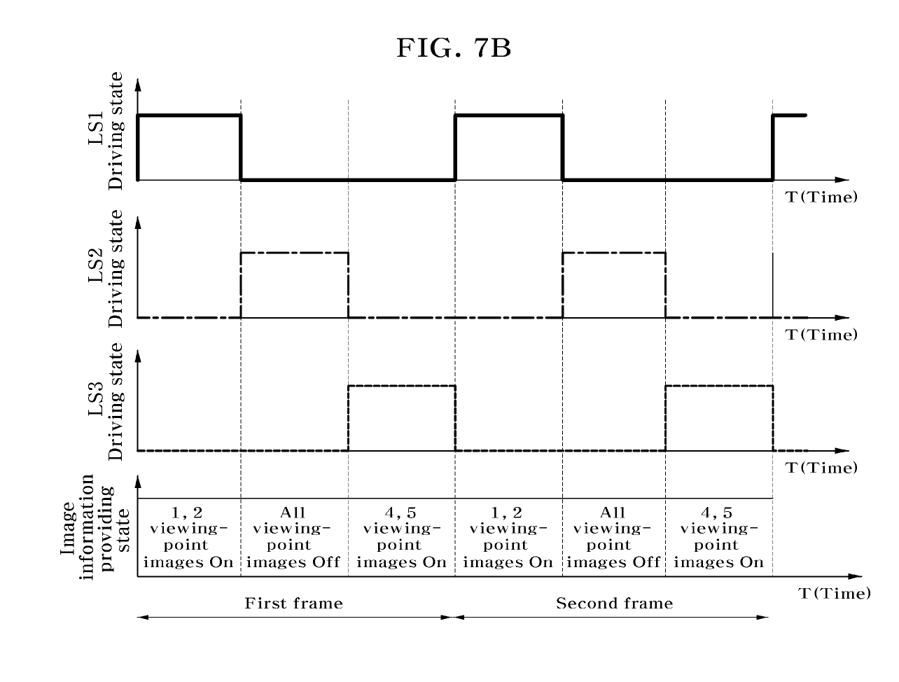

Furthermore, by simultaneously applying the viewing zone extension scheme and a time division scheme, the optimum 3D image in which brightness change and crosstalk are minimized in three-dimensional movement separately including depth can be provided for two or more viewers. Hereinafter, in the present embodiment, a case in which there are two viewers will be described with reference to FIGS. 7A and 7B.

FIGS. 7A and 7B are conceptual diagrams for describing a method of providing a 3D image to two viewers in a 3D image display device using a time division scheme according to another embodiment of the present invention.

In FIG. 7A, the number of viewing points is six, three line sources are allocated to one 3D pixel line, each eyeball of viewer 1 is located at a first viewing point and a second viewing point among a plurality of viewing points formed by a first line source respectively, and each eyeball of viewer 2 is located at a 4″ viewing point and a 5″ viewing point among a plurality of viewing points formed by a third line source respectively. Also, different complicated cases are possible, but, as an example, the simplest case will be described for describing the principle of applying the time division scheme to a case in which there are two viewers.

As shown in FIG. 7B, three line source sets in each 3D pixel line are driven quickly in an image-sticking duration in the time division scheme. In this case, as shown in FIG. 7B, the controller provides a first viewing-point image and a second viewing-point image when the first line source is being driven, and, by removing the other viewing-point images, a viewing-point image is provided to both eyes of viewer 1. The controller removes all viewing-point images when a second line source is driven, provides a fourth viewing-point image and a fifth viewing-point image when a third line source is driven, and removes the other viewing-point images, thereby providing a viewing-point image to both eyes of viewer 2. As a result, the pupils of both eyes of each of viewers 1 and 2 are located near the center of a viewing zone formed by the line source sets and a viewing-point image, thus providing a clear 3D image.

Such a time division scheme may be applied to a case in which there are two viewing points and one viewer. Also, even when the number of viewers is two or more, by preparing a plurality of viewing points more than or equal to a minimum number of viewing points (the number of viewers x two), an optimum 3D image can be provided irrespective of the number of viewers.

The autostereoscopic 3D image display device using extension of a viewing zone width according to the present invention may also be applied to a case in which a viewing image is provided for each 3D pixel line. That is, by using the 3D position information on a viewer's eyes, the controller provides a viewing-point image, in which the center of a viewing zone of a viewing point is closest to a position corresponding to each of the viewer's eyes, in synchronization with one of three or more line source sets for each 3D pixel line, and removes the other viewing-point images.

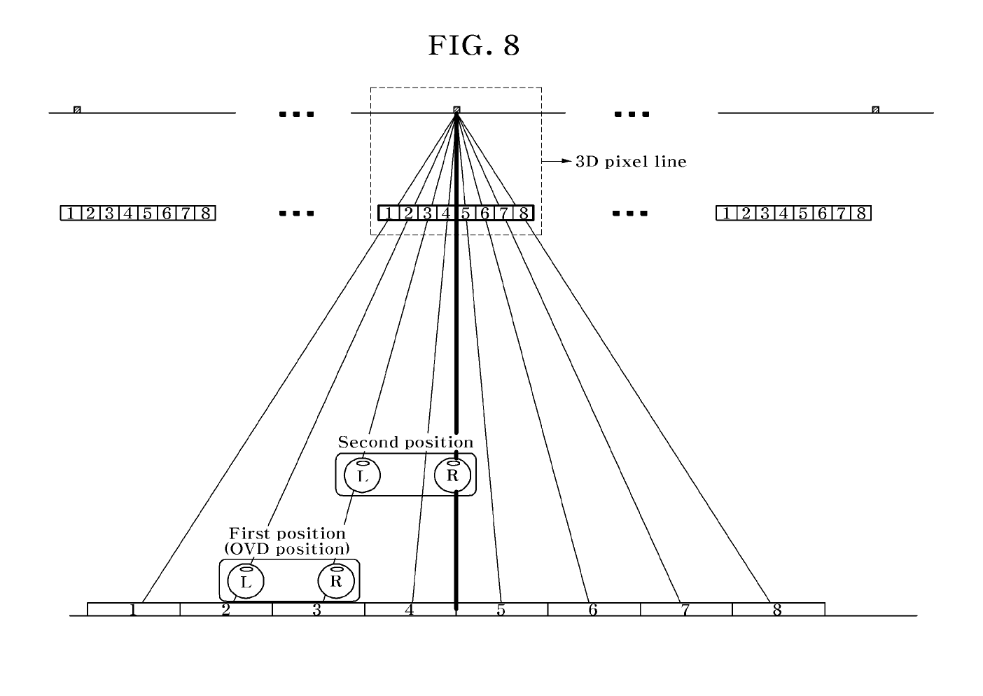

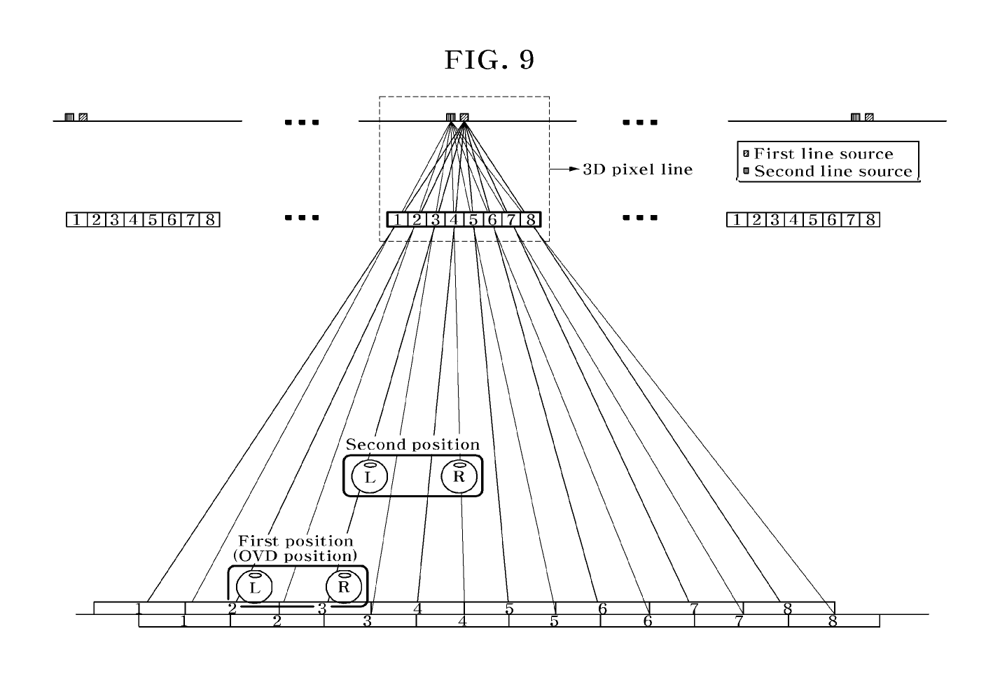

The need to apply the present invention for each 3D pixel line will be described with reference to FIG. 8. FIG. 8 shows a case that uses only one line source. In this case, when both eyes of a viewer are located at a first position, the viewer views a 3D image with minimal crosstalk. However, when it is assumed that both eyes of a viewer move to a second position, the left eye of the viewer views a 3D image with minimal crosstalk, but the pupil of the right eye of the viewer is located at the center between number 4 viewing zone and number 5 viewing zone, and thus when respective viewing-point images of two pixels are provided, crosstalk is maximized. In this case, when only the viewing-point image of one of the two pixels is provided, brightness is changed, or depending on the case, the change in brightness is not viewed according to the precision of pupil tracking Therefore, the right eye views a case in which crosstalk is high or brightness is low. Considering this case for each 3D pixel line, when the left and right eyes deviate from the optimum depth, at least a certain amount of crosstalk is viewed on average, or brightness is changed. Thus, to solve the case of FIG. 8 for each 3D pixel line, in applying the viewing zone extension scheme of the present invention (see FIG. 3A), when three line source sets are used, and a viewing-point image corresponding to a corresponding line source for each 3D pixel line is provided according to the positions of the pupils of both eyes, crosstalk is minimized and change in brightness is minimized in all conditions. Accordingly, the case of FIG. 9 may be considered. That is, considering a plurality of 3D pixel lines that include two line sources (which operates in time division) at the center, as in the case of FIG. 8, the left eye of a second position's viewer is satisfied by providing a left-eye image to corresponding number 3 pixel when a first line source operates. However, unlike in FIG. 8, providing a right-eye Image to one of number 4 pixel and number 5 pixel when a right line source operates, since the right eye of the second position's viewer is located at the end boundary of a corresponding viewing zone, the right eye views a change in brightness of a corresponding viewing zone, or cannot view the change in brightness according to the precision of pupil tracking When providing an image to all of two pixels, the maximized crosstalk of the two pixels are viewed. However, when second line source operates, providing an image 4′ to number 4 left-eye pixel, since a right eye is located at a central viewing zone thereof, a corresponding pixel for a right-eye image that satisfies the optimum condition is viewed. In the present embodiment, only a 3D pixel line that is configured with two central line sources is considered, but when applying all 3D pixel lines in the method of FIG. 9, the optimum 3D image in which crosstalk is minimized or a decrease in brightness is minimized can be viewed in all conditions. That is, even though a viewer moves in a depth direction, by synchronizing and operating a pixel and a line source corresponding to the pixel viewing zone of a line source closest to the center of a left eye or a right eye among viewing zones formed by second line source and a first line source for every 3D pixel, an autostereoscopic 3D image display device in which crosstalk is minimized or change in brightness is minimized can be implemented. Such a method may be applied to a case in which depths differ, in consideration of an application example for the plurality of viewers of FIG. 7A.

In this way, a 3D pixel line is defined, and then the controller of the image display device receives the positions of the pupils of a viewer that are fed back from the pupil position tracking system, dynamically resets a plurality of 3D pixel lines in the image display panel, and sets a viewing point corresponding to a left-eye pupil and a viewing point corresponding to a right-eye pupil with respect to a viewing point closest to the center of the pupils of both eyes among viewing points in which respective 3D pixel lines are formed. Furthermore, by removing the other viewing-point images, crosstalk is minimized, or change in brightness of a corresponding image is minimized.

As described above, the present invention designs an interval between adjacent viewing points greater than a binocular distance unlike in a general autostereoscopic two or more multi-viewing point 3D display device in which the interval between adjacent viewing points is within a general binocular distance (65 mm), allocates three or more line sources to one 3D pixel line, and determines the position of a viewer in a 3D space to dynamically generate a viewing-point image by using the pupil tracking system, thus dynamically minimizing crosstalk to the pupil of the viewer even when the viewer is moving in the 3D space, minimizing change in the brightness of a viewing-point image corresponding to the pupil, and enabling a plurality of viewers to view a natural 3D image. Especially, the present invention provides a 3D image display device in which reduction of the resolution of a 3D image due is minimized independently from an increase in the number of used line light sets.

It will be apparent to those skilled in the art that various modifications can be made to the above-described exemplary embodiments of the present invention without departing from the spirit or scope of the invention. Thus, it is intended that the present invention cover all such modifications provided they come within the scope of the appended claims and their equivalents.

What is claimed is:

1. A three-dimensional (3D) image display device, comprising:
a backlight configured to comprise a plurality of line sources which are disposed at certain intervals;
an image display panel configured to display a 3D image;
a controller configured to control the backlight and a viewing-point image of the image display panel; and
a viewer position tracking system configured to determine pupil positions of a viewer and transfer position information to the controller,
wherein,
the image display panel provides two or more viewing points,
the line sources configure three or more line source sets that are separately driven, and
the controller adjusts a viewing-point width of a unit viewing point and the distance between adjacent viewing points to be 1.5 or more times the distance between both eyes of a viewer.

2. The 3D image display device of claim 1, wherein,
each of the line sources is one of a self-emitting light source including an LED, an OLED, and an FED, or
each of the line sources is configured with an electrical high-speed shutter element including a light source and an FLCD, or a DMD.

3. The 3D image display device of claim 1, wherein the controller provides a viewing-point image to the image display panel in synchronization with one of the three or more line sources that is selected and driven according to a signal from the viewer position tracking system.

4. The 3D image display device of claim 3, wherein,
the signal from the viewer position tracking system comprises real-time 3D position information on both eyes of the viewer, and
the controller provides a viewing-point image in which a position corresponding to each eye of the viewer is closest to a center of a viewing zone of a viewing point, and removes other viewing-point images, in synchronization with one of the three or more line source sets.

5. The 3D image display device of claim 4, wherein by using the 3D position information on both eyes of the viewer, the controller provides the viewing-point image in which the position corresponding to each eye of the viewer is closest to the center of the viewing zone of the viewing point, and removes the other viewing-point images, in synchronization with one of the three or more line source sets for each 3D pixel line.

6. The 3D image display device of claim 1, wherein the controller provides a viewing-point image to the image display panel in synchronization with the three or more line sources that are sequentially driven in a time division scheme, according to the signal from the viewer position tracking system.

7. The 3D image display device of claim 4, wherein the controller provides a viewing-point image to the image display panel in synchronization with the three or more line sources that are sequentially driven in a time division scheme, according to the signal from the viewer position tracking system.

8. The 3D image display device of claim 5, wherein the controller provides a viewing-point image to the image display panel in synchronization with the three or more line sources that are sequentially driven in a time division scheme, according to the signal from the viewer position tracking system.

9. The 3D image display device of claim 6, wherein when there are a plurality of viewers, the viewer position information comprises position information on both eyes of each of the plurality of viewers.

10. The 3D image display device of claim 7, wherein when there are a plurality of viewers, the viewer position information comprises position information on both eyes of each of the plurality of viewers.

11. The 3D image display device of claim 8, wherein when there are a plurality of viewers, the viewer position information comprises position information on both eyes of each of the plurality of viewers.

12. The 3D image display device of claim 1, wherein when N number (where N is an integer from three to sixteen) of line source sets are provided and the interval between unit viewing points and the distance between adjacent viewing points are N/2 of the distance between both eyes of the viewer in a viewing position, a plurality of viewing points formed by one of the line source sets and the image display panel move by 1/N of the interval between the unit viewing points from viewing points formed by the other of the line source sets which is adjacent to the one of the line source sets and the image display panel.

13. The 3D image display device of claim 1, wherein a line width of each of the line sources is within 25% of a width of a horizontal pixel in the image display panel.
